(19) United States
(12) Patent Application Publication
(10) Pub. No.: US 2019/0003436 A1
(43) Pub. Date: Jan. 3, 2019

(54) FUEL INJECTION DEVICE

(71) Applicant: Hitachi Automotive Systems, Ltd., Hitachinaka-shi, Ibaraki (JP)

(72) Inventors: Yoshihito YASUKAWA, Tokyo (JP); Kiyotaka OGURA, Hitachinaka-shi (JP); Takao MIYAKE, Hitachinaka-shi (JP); Akira IIZUKA, Hitachinaka-shi (JP); Akiyasu MIYAMOTO, Tokyo (JP); Kazuki YOSHIMURA, Tokyo (JP)

(73) Assignee: Hitachi Automotive Systems, Ltd., Hitachinaka-shi, Ibaraki (JP)

(21) Appl. No.: 16/065,966

(22) PCT Filed: Nov. 14, 2016
(86) PCT No.: PCT/JP2016/083629

§ 371 Date: Jun. 25, 2018

(30) Foreign Application Priority Data
Jan. 12, 2016 (JP) 2016-003172

(51) Int. Cl. F02M 61/12; F02M 51/06; F02M 61/18

(52) U.S. Cl. CPC F02M 61/12; F02M 61/1833; F02M 61/182; F02M 51/061

(57) ABSTRACT

An object of the present invention is to provide a fuel injection device in which variations in an injection flow rate for each injection is suppressed and an injection amount is stabilized.

The fuel injection device according to the present invention includes: a valve element that is seated on or unseated from a valve seat; a plurality of guide parts (302a, 302b, 302c) that slidably guide the valve element; and flow paths (306a, 306b, 306c) sandwiched between the guide parts in a circumferential direction. In the fuel injection device, one guide part (302a) among the plurality of guide parts is formed to have a longer circumferential length than that of other guide parts (302b, 302c).

### TECHNICAL FIELD

The present invention relates to a fuel injection device, and particularly to a fuel injection device used for an internal combustion engine.

### BACKGROUND ART

In a fuel injection device that injects fuel to an internal combustion engine, PTL 1 is known as an invention for improving controllability of a fuel spray shape. PTL 1 describes a fuel injection device including a valve element, a plurality of fuel passages formed around the valve element, a plurality of swirl passages parallel to a direction perpendicular to the valve element, and a valve element guide hole to guide the valve element.

### CITATION LIST

### Patent Literature

PTL 1: JP H10-331739 A

### SUMMARY OF INVENTION

### Technical Problem

In a fuel injection device, in order to improve combustion stability of an internal combustion engine, it is required to reduce variations in a flow rate for each injection of the fuel injection device. When a radial force acting on the valve element at a time of valve opening is not stable, the valve element moves in an unspecified direction with a slight gap existing between the valve element and the valve element guide hole. Therefore, a flow of fuel flowing into an injection hole may vary every time the fuel injection device injects, causing variations in an injection flow rate.

In view of the problem above, it is an object of the present invention to provide a fuel injection device in which variations in an injection flow rate for each injection is suppressed and the injection amount is stabilized.

### Solution to Problem

In order to achieve the above object, the fuel injection device according to the present invention is formed with a guide member to generate a pressure difference in a specific radial direction with respect to the valve element at a time of valve opening. Specifically, in the fuel injection device including: a valve element that is seated on or unseated from a valve seat; a plurality of guide parts that slidably guide the valve element; and a flow path sandwiched between the guide parts in a circumferential direction, one guide part among the plurality of guide parts is formed to have a longer circumferential length than that of other guide parts.

### Advantageous Effects of Invention

According to a configuration of the present invention, it is possible to provide a fuel injection device in which variations in an injection flow rate for each injection is suppressed and the injection amount is stabilized.

### BRIEF DESCRIPTION OF DRAWINGS

FIG. 1 is a cross-sectional view showing a structure of a fuel injection device according to Example 1.

FIG. 2 is an enlarged cross-sectional view of an injection hole forming member of the fuel injection device according to Example 1.

FIG. 3 is an enlarged cross-sectional view of a flow path around a fuel injection hole, indicated by reference numeral 3 in FIG. 1.

FIG. 4 is an enlarged cross-sectional view of an electromagnetic drive part of the fuel injection device, indicated by reference numeral 4 in FIG. 1.

FIG. 5 is a view for explaining an operation of a valve element of the fuel injection device according to Example 1.

FIG. 6 is a view showing an arrangement of the fuel injection hole and the flow path in Example 1.

FIG. 7 is a view showing a spray shape formed by the fuel injection hole in Example 1.

FIG. 8 is an enlarged cross-sectional view of a flow path around a fuel injection hole of a fuel injection device according to Example 2.

FIG. 9 is a view showing an arrangement of the fuel injection hole and the flow path in Example 2.

FIG. 10 is a view showing a spray shape formed by the fuel injection hole in Example 2.

FIG. 11 is a view showing an arrangement of a fuel injection hole and a flow path in Example 3.

FIG. 12 is a view showing an arrangement of a fuel injection hole and a flow path in Example 4.

FIG. 13 is a view showing a spray shape formed by the fuel injection hole in Example 4.

FIG. 14 is a view showing an arrangement of a fuel injection hole and a flow path in Example 5.

### DESCRIPTION OF EMBODIMENTS

Hereinafter, examples of a fuel injection device according to the present invention will be described with reference to the drawings. Same elements are denoted by same reference numerals in each figure, and redundant explanations are omitted. Note that the present invention is not limited to the examples described below, and various modifications may be included. For example, the examples described below are illustrated in detail to facilitate description of the present invention for easy understanding, and are not necessarily limited to the examples that include all the configurations. Additionally, a part of a configuration of an example may be replaced with a configuration of another example, and a configuration of an example may be added with a configuration of another example. Moreover, a part of a configuration of each example may be deleted, replaced, or added with another configuration.

### Example 1

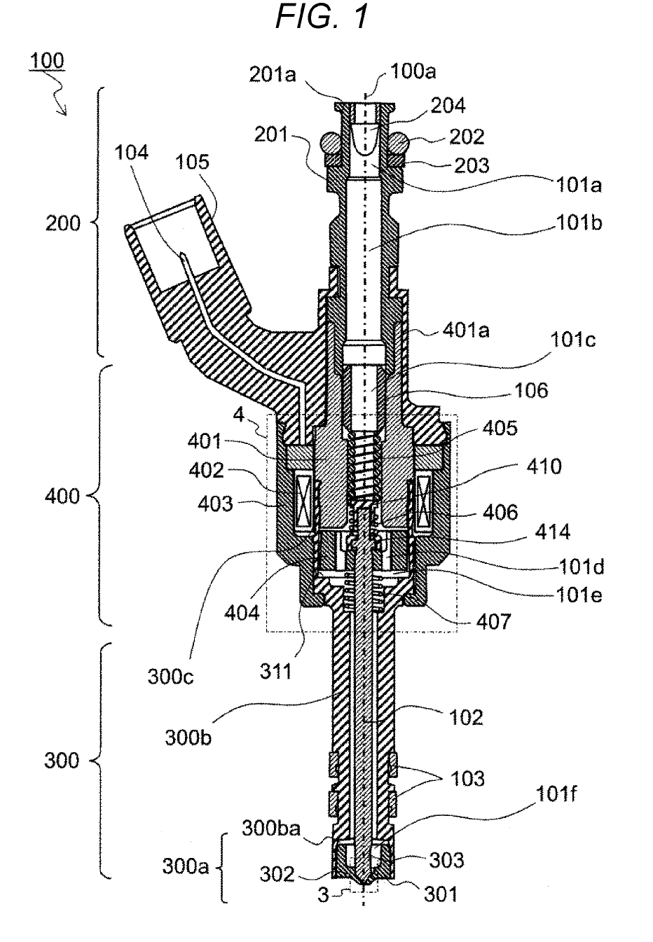

A configuration of a fuel injection device 100 according to Example 1 will be described with reference to FIGS. 1 to 7. In this example, an electromagnetic fuel injection device for an internal combustion engine that uses gasoline as fuel will be described as an example.

FIG. 1 is a cross-sectional view showing a structure of the fuel injection device 100 according to Example 1. FIG. 1 is a vertical cross-sectional view of a cross section passing through a center axis 100a of the fuel injection device 100.

The fuel injection device 100 has a fuel supply part 200 that supplies fuel, a nozzle part 300, and an electromagnetic drive part 400. The nozzle part 300 is provided with a valve part 300a that allows and interrupts a distribution of fuel, at a tip portion. The electromagnetic drive part 400 drives the valve part 300a. In this example, the fuel supply part 200 is disposed at an upper end side in the figure, and the nozzle part 300 is disposed at a lower end side in the figure. The electromagnetic drive part 400 is disposed between the fuel supply part 200 and the nozzle part 300. That is, the fuel supply part 200, the electromagnetic drive part 400, and the nozzle part 300 are arranged in this order along a direction of the center axis 100a. Hereinafter, description will be given while referring a side disposed with the fuel supply part 200 with respect to the nozzle part 300 as an upstream side, and a side disposed with the nozzle part 300 side with respect to the fuel supply part 200 as a downstream side, according to the fuel flow direction. Note that the fuel supply part 200, the valve part 300a, the nozzle part 300, and the electromagnetic drive part 400 indicate corresponding portions with respect to the cross section shown in FIG. 1, and do not indicate a single component.

In the fuel supply part 200, a fuel pipe (not shown) is connected to the upstream side of the fuel supply part 200. The nozzle part 300 is inserted into a mounting hole (insertion hole) formed in an intake pipe (not shown) or a combustion-chamber forming member (cylinder block, cylinder head, or the like) of the internal combustion engine. The electromagnetic fuel injection device 100 receives fuel from the fuel pipe through the fuel supply part 200, and injects fuel from a tip portion of the nozzle part 300 into the intake pipe or the combustion chamber. Inside the fuel injection device 100, a fuel passage 101 (101a to 101f) is formed such that the fuel flows substantially along the center axis 100a direction of the electromagnetic fuel injection device 100 from the upstream side of the fuel supply part 200 to the downstream side of the nozzle part 300.

In the following description, both end portions in a direction along the center axis 100a of the fuel injection device 100 will be described with an end portion side on the upstream side as a base end side while referring an end portion side on the downstream side as a tip end side. An end portion on the base end side of the fuel supply part 200 is a base end portion, and an end portion on a tip end side of the nozzle part 300 is a tip portion. In the following description, “upper” or “lower” will be described with reference to the vertical direction in FIG. 1. However, such a description is not intended to limit the mounting configuration of the fuel injection device to an internal combustion engine in this vertical direction.

The fuel supply part 200 is configured to include a fuel pipe 201. At an upper end portion of the fuel pipe 201, a fuel supply port 201a is provided. On an inner peripheral side of the fuel pipe 201, the fuel passage 101a is formed. The fuel passage 101a penetrates the fuel pipe 201 along the center axis 100a. A fixed iron core 401 to be described later is joined to a lower end portion of the fuel pipe 201.

On an outer peripheral side of the upper end portion of the fuel pipe 201, an O-ring 202 and a backup ring 203 are provided. The O-ring 202 functions as a seal to prevent fuel leakage when the fuel supply port 201a is mounted to the fuel pipe. The backup ring 203 is for backing up the O-ring 202. The backup ring 203 may be formed with a plurality of ring-shaped members laminated. On the inner peripheral side of the fuel supply port 201a, there is disposed a filter 204 that filters foreign matter mixed in the fuel.

The nozzle part 300 is configured to include the valve part 300a and a nozzle body 300b. The valve part 300a is formed at a lower end portion of the nozzle body 300b. The nozzle body 300b is a hollow cylindrical body. On an inner peripheral side of the nozzle body 300b, the fuel passage 101f is formed. The fuel passage 101f is formed on the upstream side of the valve part 300a. A tip seal 103 is provided on an outer peripheral surface of the nozzle body 300b. The tip seal 103 is provided to maintain airtightness at a time of mounting on an internal combustion engine.

The valve part 300a includes an injection hole forming member 301, a guide part 302, and a valve element 303. The valve element 303 is provided on a tip end side of a plunger rod 102.

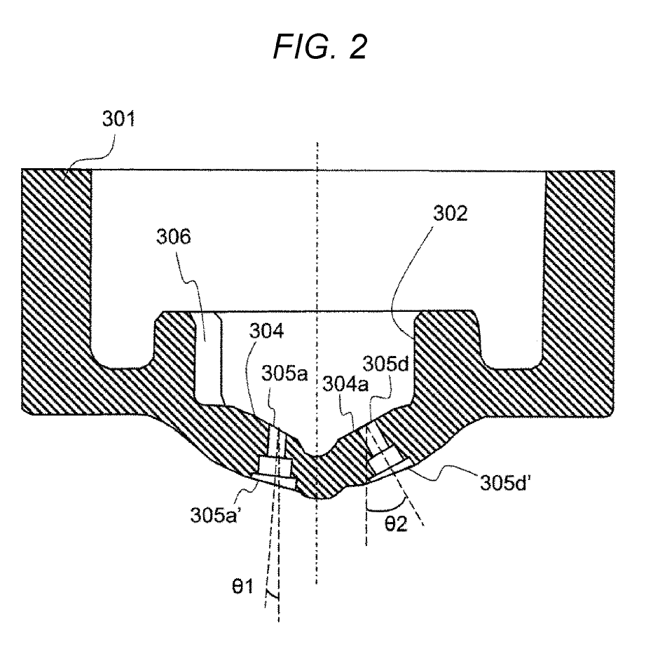

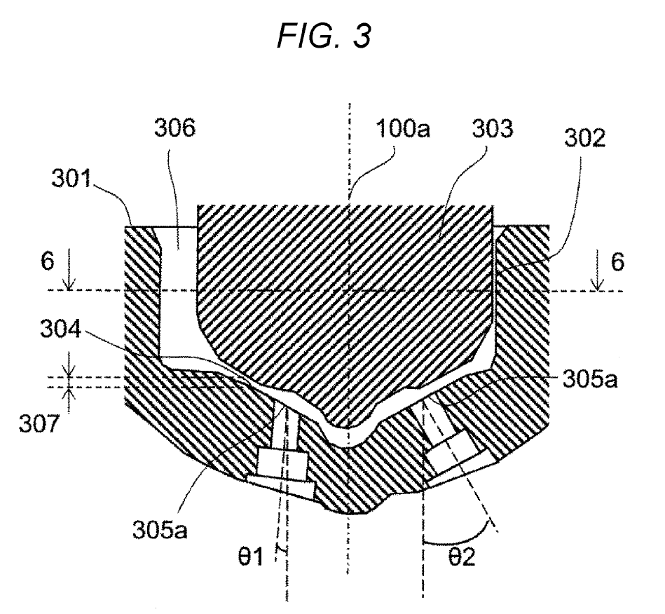

The injection hole forming member 301 is inserted into a recess inner peripheral surface 300ba formed at the tip portion of the nozzle body 300b. An outer periphery of a tip end face of the injection hole forming member 301 and an inner periphery of a tip end face of the nozzle body 300b are fixed by welding. This causes the fuel to be sealed between the injection hole forming member 301 and the nozzle body 300b. A configuration of the valve part 300a will be described in detail with reference to FIGS. 2 and 3.

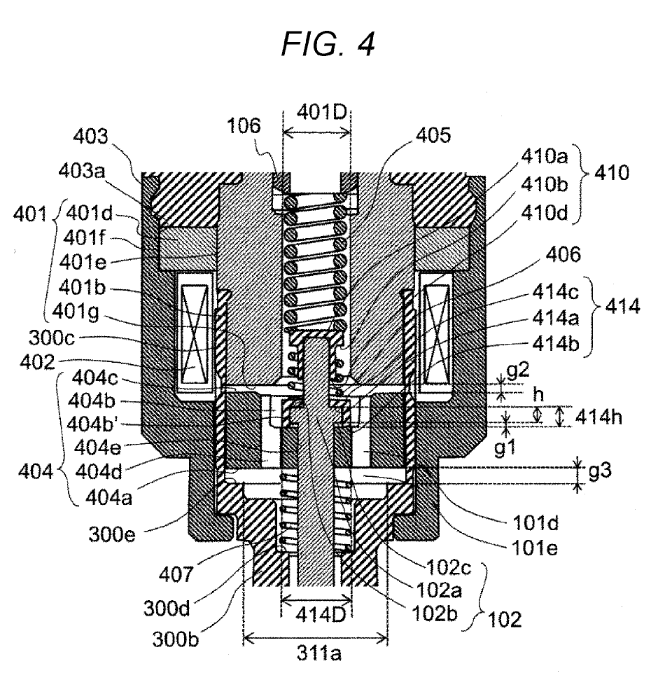

The electromagnetic drive part 400 has the fixed iron core 401, a coil 402, a housing 403, a movable iron core 404, a first spring member 405, a third spring member 406, a second spring member 407, a plunger cap 410, and an intermediate member 414. The fixed iron core 401 is also referred to as a fixed core. The movable iron core 404 is also referred to as a movable core, a movable element, or an armature. A configuration of the electromagnetic drive part 400 will be described in detail with reference to FIG. 4.

The fixed iron core 401 has the fuel passage 101c in a center portion, and a joint part 401a with the fuel pipe 201. A spring force adjusting member 106 abutting against the first spring member 405 is disposed on an inner peripheral side of the fixed iron core 401. In addition, the nozzle body 300b has a movable iron core receiving part 300e below the movable iron core 404.

FIG. 2 is an enlarged cross-sectional view showing a configuration of the injection hole forming member 301. The injection hole forming member 301 has a flow path 306 forming a gap with the valve element 303, a seat 304 that is in contact with the valve element 303 to seal fuel, and a fuel injection hole 305 that injects fuel.

In this example, a seat surface 304 and an injection hole opening surface 304a are flush with each other. However, an embodiment is not limited to this. For example, the injection hole opening surface 304a may be on the downstream side of the seat surface 304. This enables change of a length of the fuel injection hole 305, and improves flexibility in designing the injection hole forming portion 301.

FIG. 3 is a partial enlarged view of a region indicated by reference numeral 3 in FIG. 1. FIG. 3 shows a view of a state in which the valve element 303 is open. In the valve opening state, a displacement 307 is formed between the valve element 303 and the seat 304.

The guide part 302 is on an inner peripheral side of the injection hole forming member 301 and has a slight gap with a tip end side (lower end side) of the plunger rod 102 while forming a guide surface, and serves as a guide when the plunger rod 102 moves in the direction along the center axis 100a (direction of the opening and closing valve). Although the tip of the valve element 303 has a tapered shape, a spherical shape may be used.

FIG. 4 is an enlarged cross-sectional view of the electromagnetic drive part 400, which is an enlarged view of a region indicated by reference numeral 2 in FIG. 1.

The fixed iron core 401 is fitted and joined to the inner circumference of a large diameter part 300c of the nozzle body 300b, with an outer peripheral surface 401b. The fixed iron core 401 is fitted and joined to an outer-peripheral-side fixed iron core 401d, with an outer peripheral surface 401e having a diameter larger than the outer peripheral surface 401b.

The coil 402 is wound around an outer peripheral side of the fixed iron core 401 and the large diameter part 300c of a cylindrical member. In a state of being wound around a bobbin, the coil 402 is assembled to the outer peripheral side of the fixed iron core 401 and the large diameter part 300b of the cylindrical member. A resin material is molded around its periphery. By the resin material used for this molding, a connector 105 having a terminal 104 drawn out from the coil 402 is integrally molded.

The housing 403 is provided so as to surround an outer peripheral side of the coil 402. The housing 403 constitutes an outer periphery of the fuel injection device 100. The housing 403 is connected to an outer peripheral surface 401f of the outer-peripheral-side fixed iron core 401d on an upper-end-side inner peripheral surface 403a.

The movable iron core 404 is disposed on a lower end face 401g side of the fixed iron core 401. An upper end face 404c of the movable iron core 404 is opposed to the lower end face 401g of the fixed iron core 401 via a gap g2. An outer peripheral surface of the movable iron core 404 is opposed to the inner peripheral surface of the large diameter part 300c of the nozzle body 300b via a slight gap. The movable iron core 404 is provided inside the large diameter part 300c of the cylindrical member so as to be movable in the direction along the center axis 100a. When a current is applied to the coil 402, a magnetic path is formed such that a magnetic flux circulates around the fixed iron core 401, the movable iron core 404, the large diameter part 300c of the cylindrical member, and the housing 403. Magnetic attraction force is generated by the magnetic flux flowing between the lower end face 401g of the fixed iron core 401 and the upper end face 404c of the movable iron core 404. The movable iron core 404 is attracted toward the fixed iron core 401 by the magnetic attraction force.

In a central portion of the movable iron core 404, a recessed part 404b recessed from the upper end face 404c side to the lower end face 404a side is formed. Providing the recessed part 404b of the movable iron core 404 allows the intermediate member 414 to be arranged further downward, so that a vertical length of the plunger rod 102 can be shortened. In this example, such a configuration is adopted in order to improve accuracy of the plunger rod 102. However, it is also possible to form one plane with the upper end face 404c without providing the recessed part 404b.

The movable iron core 404 is formed with a fuel passage hole 404d and a through hole 404e that penetrate in the direction along the center axis 100a. The fuel passage hole 404d penetrates from the upper end face 404c to the lower end face 404a of the movable iron core 404, and also penetrates from a bottom surface 404b′ of the recessed part 404b to the lower end face 404a. The fuel passage hole 404d functions as the fuel passage 101d. The through hole 404e penetrates from the bottom surface 404b′ of the recessed part 404b to the lower end face 404a. The through hole 404e is a through hole passing through the center axis 100a. The plunger rod 102 is passed through the through hole 404e.

On the downstream side of the movable iron core 404, the fuel passage 101e is formed. The lower end face 404a of the movable iron core 404 is opposed to the movable iron core receiving part 300e of the nozzle body 300b. The movable iron core receiving part 300e is formed on an outer peripheral side of a diameter 311a. In the nozzle body 300b, a hollow portion is formed on an inner peripheral side of the diameter 311a, as illustrated.

The movable iron core receiving part 300e is formed integrally with the nozzle body 300b. Therefore, a gap g3 between a lower surface 404a of the movable iron core 404 and the movable iron core receiving part 300e can be determined by processing of the nozzle body 300b. This enables improvement of the performance with a simple method without adding a component or the like.

The first spring member 405, the third spring member 406, and the second spring member 407 are arranged in this order from the upstream side to the downstream side. A lower end portion of the first spring member 405 urges the plunger rod 102 downward via the plunger cap 410. A lower end portion of the third spring member 406 abuts against an upper surface 414c of the intermediate member 414, to urge the intermediate member 414 in a downward direction. A lower end portion of the second spring 407 abuts against a stepped portion 300d of the nozzle body 300b. An upper end portion of the second spring member 407 abuts against the lower surface 404a of the movable iron core 404, to urge the movable iron core 404 in an upward direction.

The plunger cap 410 is fitted to the tip on the upstream side of the plunger rod 102. The plunger rod 102 has a thick diameter part 102a. The plunger cap 410 has an upper spring bearing 410a and a lower spring bearing 410b. The upper spring bearing 410a of the plunger cap 410 abuts against the lower end portion of the first spring member 405. The lower spring bearing 410b of the plunger cap 410 abuts against an upper end portion of the third spring member 406. A lower end portion 410d of the plunger cap 410 is opposed to the upper surface 414c of the intermediate member 414.

The intermediate member 414 is a cylindrical member having a recessed part. An inner peripheral surface 414a of the recessed part abuts against an upper surface 102b of the thick diameter part 102a of the plunger rod 102. An outer peripheral surface 414b of the recessed part abuts against the bottom surface 404b′ of the recessed part 404b of the movable iron core 404. A gap g1 is formed between the lower surface 102c of the thick diameter part 102a of the plunger rod 102 and the bottom surface 404b′ of the recessed part 404b of the movable iron core 404. A height h of the thick diameter part 102a of the plunger rod 102 is represented by a height from the upper surface 102b to 102c of the thick diameter part 102a. The gap g1 is a length obtained by subtracting the height h of the thick diameter part 102a of the plunger rod 102 from the height 414h of the step of the recessed part of the intermediate member 414.

An outer diameter 414D of the intermediate member 414 is formed to be smaller than an inner diameter 401D of the fixed iron core 401. This configuration enables insertion of the plunger rod 102 in a state in which the intermediate member 414, the third spring member 406, and the plunger cap 410 are assembled in advance, through the inner diameter 401D of the fixed iron core 401. Since an assembling work can be performed after the gap g1 is determined by the step height 414h of the intermediate member and the height h of the thick diameter part of the plunger rod, it is possible to stably manage the gap g1 while facilitating the assembly. In this example, the outer diameter 414D of the intermediate member 414 is made smaller than the inner diameter 401D of the fixed iron core 401. However, it is only necessary that an outermost diameter of a member to be assembled in advance is small. For example, when an outer diameter of the plunger cap 410 is larger than the outer diameter 414D of the intermediate member 414, the outer diameter of the plunger cap 410 may be made smaller than the inner diameter 401D of the fixed iron core 401.

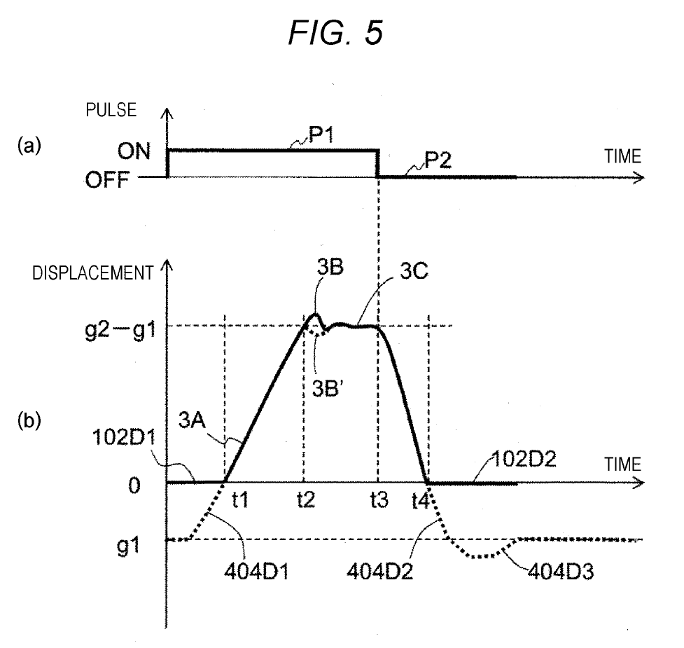

FIG. 5 is a view for explaining an operation of a movable portion. FIG. 5(a) shows an ON/OFF state of an injection command pulse. FIG. 5(b) shows a displacement of the plunger rod 102 and the movable iron core 404 when a displacement in a valve closed state of the plunger rod 102 is 0.

In a state in which the coil 402 is not energized, the plunger rod 102 abuts against the seat 304 with the urging force of the first spring member 405 and the third spring member 406 in the valve closing direction, against the urging force of the second spring member 407 in the valve opening direction. This state is called a valve-closed stationary state. In the valve-closed stationary state, the movable iron core 404 abuts against the outer peripheral surface 414b of the intermediate member 414.

In the valve-closed stationary state, the gap g1 is formed between the bottom surface 404b′ of the recessed part 404b of the movable iron core 404 and the lower surface 102c of the thick diameter part 102a of the plunger rod 102. The gap g2 is formed between the lower end face 401g of the fixed iron core 401 and the upper end face 404c of the movable iron core 404. A relationship between the gaps g1 and g2 is g2>g1. The gap g3 is formed between the lower surface 404a of the movable iron core 404 and the movable iron core receiving part 300e of the nozzle body 300b.

After energization to the coil 402 (P1 in FIG. 5(a)), a magnetomotive force is generated by the electromagnet formed by the fixed iron core 401, the coil 402, and the housing 403. This magnetomotive force causes a flow of a magnetic flux circulating around the magnetic path constituted by the fixed iron core 401, the housing 403, the large diameter part 300c of the nozzle body, and the movable iron core 404. At this time, a magnetic attraction force acts between the upper end face 404c of the movable iron core 404 and the lower end face 401g of the fixed iron core 401. This magnetic attraction force causes the movable iron core 404 and the intermediate member 414 to start to displace toward the fixed iron core 401. Then, the movable iron core 404 is displaced by g1 (404D1) until the movable iron core 404 abuts against the lower surface 102c of the thick diameter part 102a of the plunger rod 102. The movable iron core 404 abuts against the lower surface 102c of the thick diameter part 102a of the plunger rod 102 at a timing of t1. The plunger rod 102 does not move until the timing t1 (102D1).

After the movable iron core 404 abuts against the lower surface 102c of the thick diameter part 102a of the plunger rod 102 at the timing of t1, the plunger rod 102 is pulled up by an impact force from the movable iron core 404. The plunger rod 102 moves away from the seat 304 and starts a valve opening operation. A gap is formed between the seat and the valve element 303 formed at a tip portion of the plunger rod 102, and the fuel passage is opened. Since the plunger rod 102 starts to open the valve by receiving the impact force, the plunger rod 102 rises sharply (3A). Thereafter, the movable iron core 404 is displaced by g2-g1 and abuts against the lower surface 401g of the fixed iron core 401 at a timing of t2.

After the movable iron core 404 abuts against the lower surface 401g of the fixed iron core 401 at the timing of t2, the plunger rod 102 is further displaced upward (3B). Whereas, the movable iron core 404 is displaced downward (3B′) by reaction of collision with the lower surface 401g of the fixed iron core 401. Thereafter, the movable iron core 404 comes into contact with the fixed iron core 401 again with the magnetic attraction force, and displacement is stabilized at g2-g1 (3C).

At a timing of t3, when the energization to the coil 402 is interrupted (P2), the magnetic force starts to disappear. Then, the valve closing operation is started by the urging force of the spring moving in the downward direction.

After the displacement of the plunger rod 102 becomes zero at a timing of t4, the plunger rod abuts against the seat 304, to complete the valve closing (102D2). The movable iron core 404 moves to the initial position g1 after closing of the valve (404D2). The movable iron core 404 is further displaced in the downward direction by inertia, and then stops at the position g1 (404D3).

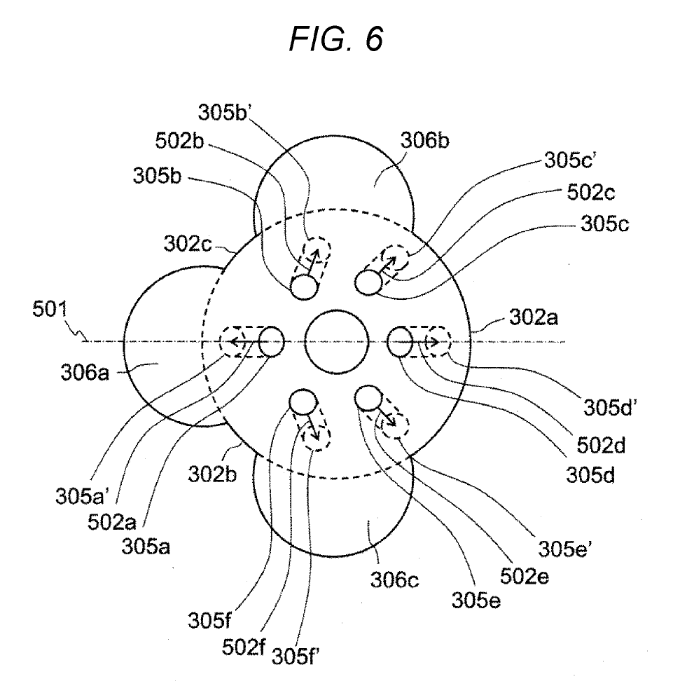

FIG. 6 is a view showing an arrangement of the fuel injection hole 305 and the flow path 306 of the fuel injection device 100 according to this example. FIG. 6 is drawn from a viewpoint when the injection hole forming member 301 is viewed from the upstream side in the direction along the center axis 100a.

As shown in FIG. 2, the fuel injection hole 305 is formed on the injection hole opening surface 304a. In this example, six fuel injection holes 305 are formed. The fuel injection holes 305 respectively have fuel injection hole inlets 305a to 305f and fuel injection hole outlets 305a′ to 305f′. Directions from the fuel injection hole inlets 305a to 305f to the fuel injection hole outlets 305a′ to 305f′ are defined as injection directions 502a to 502f, respectively.

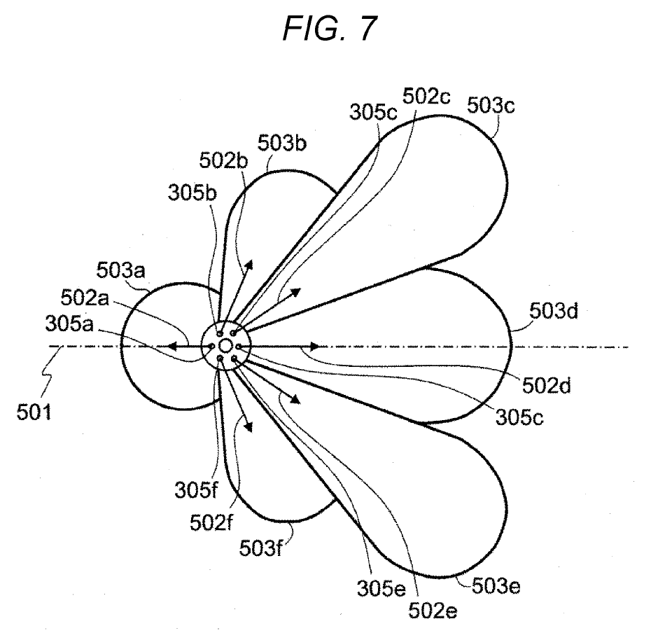

FIG. 7 schematically illustrates a shape of a fuel spray 503 injected from the fuel injection hole 305 of this example. Fuel sprays injected from the fuel injection hole outlets 305a′ to 305f′ are referred to as fuel sprays 503a to 503f, respectively. The fuel sprays 503a to 503f have a shape that is plane-symmetrical with respect to a symmetric plane 501 of spray.

Returning to FIG. 6, the explanation is started. In this example, the guide part 302 formed in the injection hole forming member 301 includes guide parts 302a, 302b, and 302c. The flow path 306 includes flow paths 306a, 306b, and 306c. The guide parts 302a to 302c and the flow paths 306a to 306c are alternately arranged in the circumferential direction.

As a characteristic configuration of the fuel injection device 100 according to this example, the guide part 302a has a longer circumferential length than that of the other guide parts 302b and 302c. That is, the flow paths 306a to 306c are arranged such that an interval between the flow path 306b and the flow path 306c is larger than an interval between other flow paths. It can be also said that individual centers of the plurality of flow paths 306a to 306c are arranged unevenly in the circumferential direction.

At a time of the valve opening operation, fuel flows through the guide part 302 and the flow path 306 by a side of the valve element 303. A flow velocity of the fuel flowing by the side of the valve element 303 causes a fluid force acting in the radial direction on the valve element 303. When the flow velocity flowing by the side of the valve element 303 is high, a pressure loss of the fuel flowing by the side increases. This causes a pressure difference in the radial direction, and generates a force so as to draw the valve element 303.

As a comparative example, a case will be described in which a plurality of flow paths and guide parts formed by the side of the valve element are arranged symmetrically in the circumferential direction. In such a configuration, a fluid force acting on the valve element is substantially equilibrium. Then, a movement of the valve element in the direction orthogonal to a direction of the valve opening operation may not be kept constant, and the valve element may be displaced in a different direction at each injection of the fuel injection device. Since the seat in contact with the valve element is typically formed by a conical surface, the gap between the valve element and the seat varies also by a radial movement of the valve element. The gap between the valve element and the seat is formed on the upstream side of the fuel injection hole, and is related to the flow rate of the fuel flowing into the fuel injection hole. Therefore, it is important that the gap becomes constant for each injection. If the displacement of the valve element is unstable, the flow rate of the fuel flowing into the fuel injection hole varies for each injection.

In a case of this example, among the plurality of guide parts 302, the guide part 302a disposed between the flow path 306b and the flow path 306c is formed to be the longest. The fluid force generated between the guide part 302a and the valve element 303 becomes relatively large. Therefore, the valve element 303 is drawn in the right direction in FIG. 3 and FIG. 6. That is, the valve element 303 opens while being drawn to the guide part 302a side.

Specifically, in the fuel injection device 100 of this example, the guide part 302a and the flow path 306a are arranged diametrically opposed to each other with the central axis 100a of the fuel injection device 100 interposed in between. In addition, the flow path 306b and the flow path 306c are arranged so as to sandwich the valve element 303 along a direction orthogonal to the direction in which the guide part 302a and the flow path 306a are disposed (a direction parallel to the symmetric plane 501 of spray).

As described above, in the fuel injection device 100 of this example, the circumferential arrangement of the flow path 306 formed by the side of the valve element 303 is intentionally uneven. The force acting on the valve element 303 acts in a specific direction during the valve opening operation. This prevents variations in the fluid gap formed between the seat 304 and the valve element 303 for each valve opening operation. Since the flow of the fuel flowing into the fuel injection hole does not vary for each injection, variations in an injection flow rate can be reduced.

In this example, as described above, one of major objectives is to reduce variations in an injection flow rate at a time of valve opening operation. In the fuel injection device according to this example, as described in FIG. 5, the impact force from the movable iron core 404 causes the valve element 303 to perform a sharp opening and closing valve operation. Such a fuel injection device can reduce the injection amount of fuel to be injected by one opening and closing valve. In the fuel injection device of this example, by reducing variations in an injection flow rate in such a fuel injection device that performs a micro injection amount control, it is possible to obtain better micro-injection characteristics at the initial stage of valve opening.

In this example, since the circumferential interval between the flow paths 306b and 306c is formed to be wider than other intervals, it is easier for fuel to flow on the flow path 306a side (the left side in the figure) than the guide part 302a side (the right side in the figure). That is, the fuel is more likely to flow toward the fuel injection hole inlet 305a than the fuel injection hole inlet 305d.

As shown in FIG. 2, assuming that an angle formed between the central axis 100a of the fuel injection valve 100 and a boring direction from the fuel injection hole inlet 305a to the fuel injection hole outlet 305a′ is θ1, and that an angle formed between the central axis 100a of the fuel injection valve 100 and a boring direction from the fuel injection hole inlet 305d to the fuel injection hole outlet 305d′ is θ2, the angle θ1<the angle θ2. With such a configuration, a delamination area of fuel flowing into the fuel injection hole inlet 305a is smaller than a delamination area of fuel flowing into the fuel injection hole inlet 305d.

In this way, unevenly disposing the guide part 302 causes the fuel to easily flow into the fuel injection hole inlet 305a. However, by bringing the boring direction from the fuel injection hole inlet 305a to the fuel injection hole outlet 305a′ close to the central axis 100a of the fuel injection device 100, the delamination area can be suppressed to be small, and variations in the fuel injection amount can be reduced. Therefore, it is possible to further improve the reduction effect on variations in the injection amount.

In this example, hole diameters of the fuel injection holes 305 are all the same, but the hole diameters of the fuel injection holes 305 may be individually changed. For example, the hole diameter on the fuel injection hole 305a side having a relatively large fuel flow rate can be made larger than the hole diameter on the fuel injection hole 305d side. Even in this case, the delamination area can be made relatively small, and variations in the flow rate of the fuel injection device as a whole can be reduced.

In this example, the circumferential lengths of the guide parts 302b and 302c are made equal. However, as long as the length of the guide part 302a is the longest, there is no particular difference in the operational effect even if there is a difference in the lengths of the guide parts 302b and 302c.

### Example 2

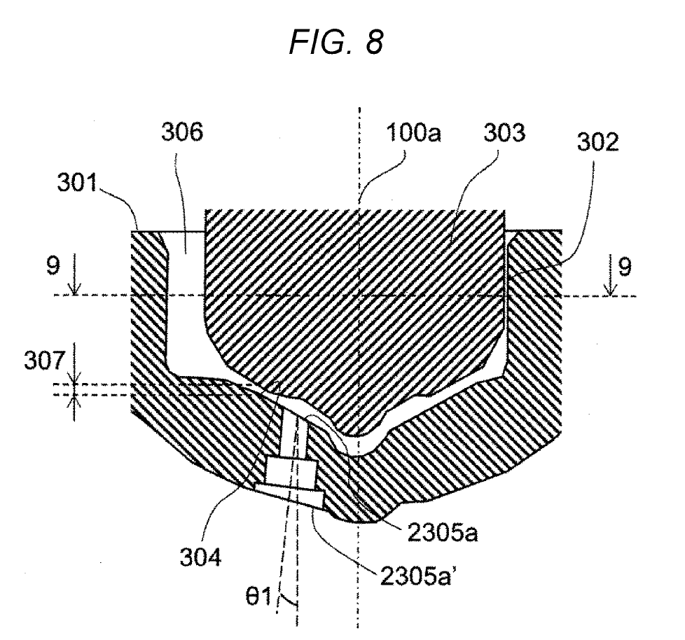

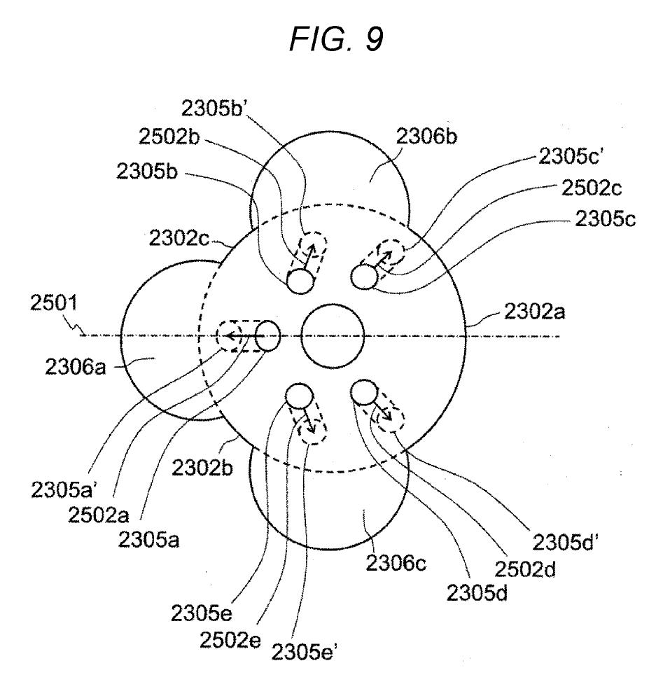

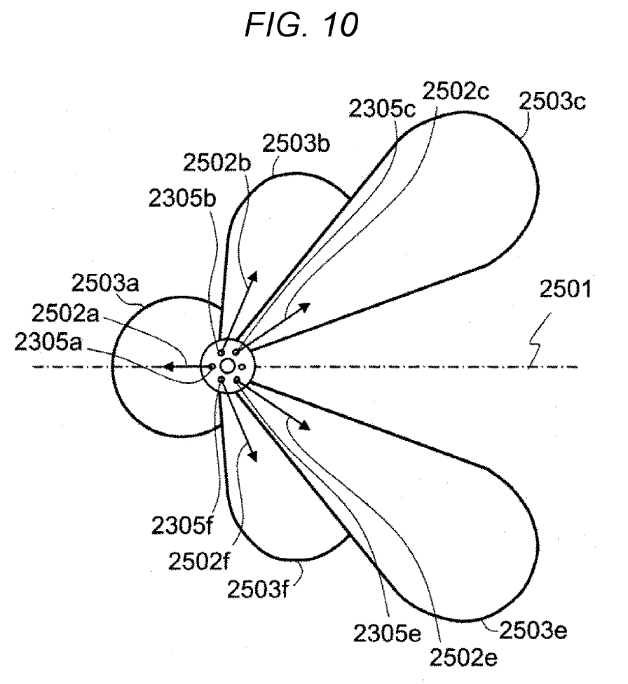

A configuration of a fuel injection device 100 according to Example 2 will be described with reference to FIGS. 8 to 10. A difference from Example 1 is that the number of fuel injection holes is different. A fuel injection hole 2305 in this example is constituted of five fuel injection holes. Only the fuel injection hole indicated by reference numeral 2305a is a fuel injection hole formed on a symmetric plane 2501 of spray.

Since a circumferential length of a guide part 2302a is longer than that of other guide parts 2302b and 2302c, an amount of fuel flowing into the fuel injection hole 2305a formed on an opposite side to the guide part 2302a is relatively large. On the contrary, no fuel injection hole is provided on the guide part 2302a side.

An angle θ1 formed by a central axis 100a of a fuel injection device 100 and an injection hole axis connecting a center of the fuel injection hole inlet 2305a and a center of the fuel injection hole outlet 2305a′ is formed to be smaller than an angle of other fuel injection holes.

Even in such an example, as in Example 1, it is possible to reduce variations in the fuel injection amount for each injection.

### Example 3

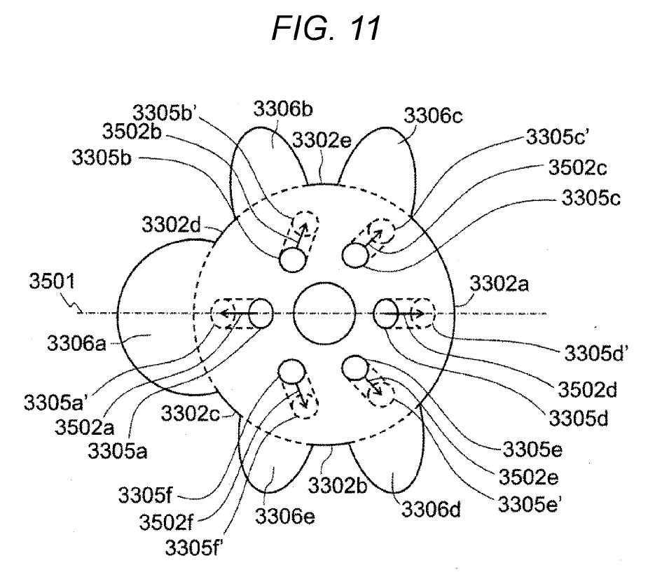

A configuration of a fuel injection device 100 according to Example 3 will be described with reference to FIG. 11. A difference from Example 1 is that a shape of a flow path 3306 is nonuniform. The flow path 3306a formed on a symmetric plane 3501 of spray has a larger cross-sectional area than that of other flow paths 3306b to 3306e. In addition, a guide part 3302a formed at a position opposed to the flow path 3306a has a longer circumferential length than that of other guide parts 3302b to 3330e. In this example as well, a valve element 303 performs a valve opening operation while moving toward the guide part 3302a side (the right direction in the figure). This causes a fluid gap formed between a seat 304 and the valve element 303 to be constant for each valve operation, enabling reduction of variations in the injection amount of the fuel injection device 100 for each drive.

### Example 4

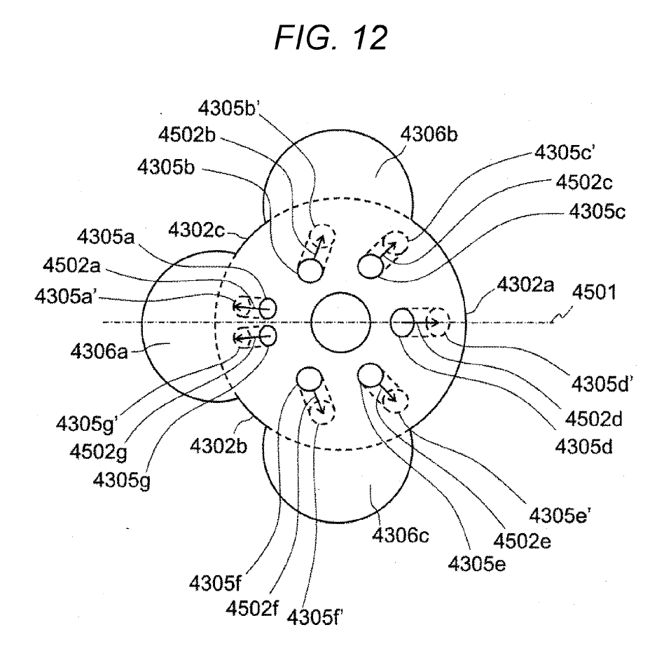

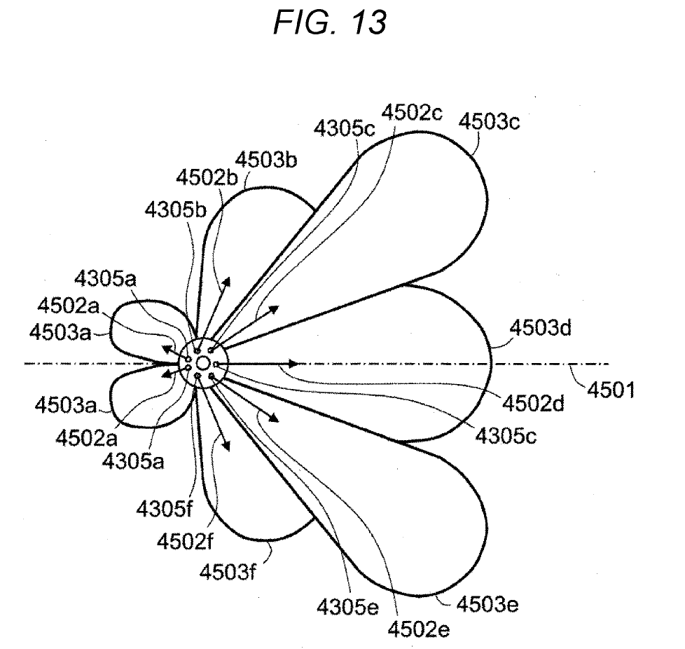

A configuration of a fuel injection device according to Example 4 will be described with reference to FIGS. 12 and 13. A difference from Example 1 is that the number of fuel injection holes is different. Only a fuel injection hole indicated by reference numeral 4305 is a fuel injection hole formed on a symmetric plane 4501 of spray, but fuel injection holes 4305a and 4305g are arranged close to the symmetric axis 4501 of spray.

Even in this case, a guide part 4302a is formed to have a longer circumferential length than that of other guide parts 4302b and 4302c. In this example as well, as in Example 1, a fluid force generated in the guide part 4302a becomes large, and a valve element 303 performs a valve opening operation while moving to the guide part 4302a side (the right direction in the figure). This allows a fluid gap formed between a seat 304 and the valve element 303 to be constant for each valve operation, enabling reduction of variations in the injection amount of the fuel injection device 100 for each drive.

In this example, fuel is more likely to flow into the fuel injection holes 4305a and 4305g than a fuel injection hole 4305d. Since the fuel injection holes 4305a and 4305g are provided, not only the reduction in variations in the injection amount is improved, but also spray shape controllability can also be improved.

### Example 5

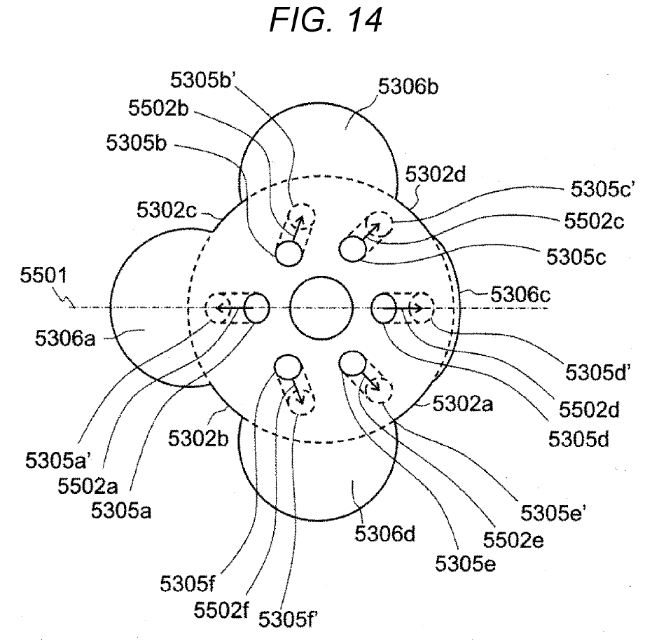

An example different from the above will be further described with reference to FIG. 14. A difference from Example 1 is that a flow path 5306c having a minute cross-sectional area is formed in a portion corresponding to the guide part 302a in Example 1.

Each of Examples 1 to 4 described above is characterized in that one guide part among the plurality of guide parts is formed to have a longer circumferential length than that of other guide parts. However, such a configuration is one example as a configuration for directing a radial force acting on a valve element in a specific direction. In each of the above-described examples, the fuel injection device is configured such that a fluid force acts around the valve element with fuel, and a pressure difference around the valve element acts to a specific direction. Various modifications are possible without departing from such a technical concept, and this example is one example thereof.

By forming a flow path having a minute cross-sectional area in a partial region around a valve element 303 as in this example, it is also possible to apply a force to the valve element 303 toward the right direction in the figure. According to this example, it is possible to reduce variations in the injection amount as the fuel injection device while supplying a minimum necessary amount of fuel to a fuel injection hole 5305d as well. In addition, abrasion between the valve element and the guide part can be suppressed. Further, it is also conceivable that a plurality of flow paths are arranged at unequal intervals in a circumferential direction by a side of the valve element, as a modification.

In each of Examples 1 to 5 described above, the guide part and the flow path are formed integrally with the injection hole forming member 305 on which the fuel injection hole is formed. In the injection hole forming member 305, the plurality of fuel injection holes are formed circumferentially. However, the invention in the present application is not limited to such an embodiment. For example, there may be separately formed a guide part to regulate a radial movement of the valve element 303, a valve seat on which the valve element 303 is seated, and the injection hole forming member formed with the fuel injection hole. Alternatively, the present invention can also be applied to a fuel injection device in which fuel flows downstream from a single fuel distribution opening formed at an apex of a conical surface constituting the valve seat.

### REFERENCE SIGNS LIST

100 fuel injection device
100a center axis
101 fuel passage
102 plunger rod
102a thick diameter part
102b upper surface
102c lower surface
103 tip seal
104 terminal
105 connector
106 spring force adjusting member
200 fuel supply part
201 fuel pipe
201a fuel supply port
202 O-ring
203 backup ring
300 nozzle part
300a valve part
300b nozzle body
300ba recess inner peripheral surface
300c large diameter part
300d stepped portion
300e movable iron core receiving part
301 injection hole forming member
302 guide part
303 valve element
304 seat
304a injection hole opening surface
305 fuel injection hole
306 flow path
400 electromagnetic drive part
401 fixed iron core
401a joint part
401b outer peripheral surface
401d outer-peripheral-side fixed iron core
401D inner diameter
401e outer peripheral surface
401f outer peripheral surface
401g lower end face
402 coil
403 housing
403a upper-end-side inner peripheral surface
404 movable iron core
404a lower surface
404b recessed part
404b′ bottom surface
404c upper end face
404d fuel passage hole
404e through hole
405 first spring member
406 third spring member
407 second spring member
410 plunger cap
410a upper spring bearing
410b lower spring bearing
410d lower end portion
414 intermediate member
414a inner peripheral surface
414b outer peripheral surface
414c upper surface
414D outer diameter
414h height of a step of a recessed part
501 symmetric plane of spray
502 injection direction
503 fuel spray
2302 guide part
2305 fuel injection hole
2306 flow path
2501 symmetric plane of spray
3302 guide part
3305 fuel injection hole
3306 flow path
3501 symmetric plane of spray
4302 guide part
4305 fuel injection hole
4306 flow path
4501 symmetric plane of spray
5302 guide part
5305 fuel injection hole
5306 flow path
5501 symmetric plane of spray

1. A fuel injection device comprising:
a valve element that is seated on or unseated from a valve seat;
a plurality of guide parts that slidably guide the valve element; and
a flow path sandwiched between the guide parts in a circumferential direction, wherein
one guide part among the plurality of guide parts is formed to have a longer circumferential length than that of another guide part.

2. The fuel injection device according to claim 1, comprising
a plurality of fuel injection holes arranged circumferentially, wherein
a fuel injection hole disposed on an opposite side to the guide part having a longest circumferential length among the plurality of fuel injection holes is formed to have a smaller angle formed between a central axis of the fuel injection hole and a central axis of the valve element than that of a fuel injection hole disposed on the guide part side having the longest circumferential length.

3. The fuel injection device according to claim 1, comprising
a plurality of fuel injection holes arranged circumferentially, wherein
a fuel injection hole disposed on an opposite side to the guide part having a longest circumferential length among the plurality of fuel injection holes is formed to have a smaller angle formed between a central axis of the fuel injection hole and a central axis of the valve element than that of another fuel injection hole.

4. The fuel injection device according to claim 1, comprising
a plurality of fuel injection holes arranged circumferentially, wherein
the plurality of fuel injection holes are arranged such that a number of the fuel injection holes arranged on the guide part side having a longest circumferential length is less than a number of the fuel injection holes arranged on an opposite side to the guide part having the longest circumferential length.

5. The fuel injection device according to claim 1, comprising
a plurality of fuel injection holes arranged circumferentially, wherein
a fuel injection hole disposed on an opposite side to the guide part having a longest circumferential length among the plurality of fuel injection holes is formed to have a larger hole diameter than that of a fuel injection hole disposed on the guide part side having the longest circumferential length.

6. The fuel injection device according to claim 1, wherein
the guide parts and the flow path are formed plane-symmetrically with respect to a symmetric plane passing through a central axis of the valve element, as a boundary.

7. The fuel injection device according to claim 6, comprising
a plurality of fuel injection holes arranged circumferentially, wherein
the plurality of fuel injection holes are formed plane-symmetrically with respect to the symmetry plane as a boundary.

8. The fuel injection device according to claim 1, wherein
the flow path is constituted by a plurality of flow paths having different shapes in a cross section perpendicular to a central axis of the valve element.

9. A fuel injection device comprising:
a plurality of guide parts to guide a side of a valve element; and
a plurality of flow paths sandwiched between the guide parts in a circumferential direction, wherein
the plurality of flow paths are arranged at unequal intervals in the circumferential direction.

10. A fuel injection device comprising:
a guide member formed with a plurality of flow paths; and
a valve element slidably inserted through the guide member, wherein
the guide member generates a pressure difference in a radial direction with respect to the valve element at a time of valve opening.
